(19) United States
(12) Patent Application Publication
(10) Pub. No.: US 2026/0080208 A1
(43) Pub. Date: Mar. 19, 2026

(54) ENTITY LINKING USING A GRAPH NEURAL NETWORK

(71) Applicant: Visa International Service Association, San Francisco, CA (US)

(72) Inventors: Sheng Wang, Austin, TX (US); Xutong Wang, Austin, TX (US); Jie Yuan, San Mateo, TX (US); Dan Wang, Cedar Park, TX (US)

(73) Assignee: Visa International Service Association, San Francisco, CA (US)

(21) Appl. No.: 19/110,486

(22) PCT Filed: Sep. 29, 2022
(86) PCT No.: PCT/US2022/077290

§ 371 Date: Mar. 11, 2025

(51) Int. Cl. G06N 3/042; G06N 3/0464; G06N 3/09

(52) U.S. Cl. CPC G06N 3/042; G06N 3/0464; G06N 3/09

(57) ABSTRACT

Entity linking using a graph neural network is disclosed. Entity linking can include tokenizing an unknown name, tokenizing a known name from a set of known names, identifying a candidate from the set of known names, and generating a tripartite graph. The tripartite graph can include a first layer node corresponding to the unknown name, second layer nodes corresponding to words of the known name and the candidate, and a third layer node corresponding to the candidate. The method can further include assigning the unknown name to one of the known names by applying the tripartite graph to a graph neural network model.

### TECHNICAL FIELD

At least some aspects of the present disclosure relate to natural language processing, such as cross-party entity linking using a graph neural network.

### BACKGROUND

In the field of natural language processing (NLP), entity linking, which is sometimes referred to as named-entity linking or named-entity matching, generally relates to determining that a word or string of words recited in text refers to a particular entity. Thus, entity linking can involve assigning a unique identity to a word or string of words. In many cases, the unique identity can be an individual or an organization, such as a company, a foundation, a charitable organization, or a governmental organization.

Entity linking can be a valuable tool for associating information with a particular individual or organization. In some aspects, this is because entity linking can enable companies to leverage the vast amount of information accessible via the Internet to evaluate entities. For example, various private and public information sources such as news articles, wikis, social media, and other databases and publications may contain information related to an entity. This information may be relevant to evaluating the entity's creditworthiness, evaluating the risk of doing business with the entity, evaluating the financial performance of the entity, etc. However, because there are potentially millions of information sources and potentially thousands or even millions of entities that the evaluating company is interested in, it can be technically difficult to manually identify information that may be relevant. Accordingly, NLP and entity linking can be used as an automated way of identifying particular entities mentioned in these information sources.

Nevertheless, several technical challenges exist related to entity linking. As one example, there is often ambiguity and inconsistency in the names used to refer to a particular entity. A news article about an entity with the legal name “United Airlines, Inc.” may instead recite the name “United” within the text or even the title of the article. Therefore, a computer-implemented process may mistake the name “United” for other entities such as “United Health Care” and “United Technology Corp.,” for example. As another example, it is difficult to create a ground truth or labeled data set for reliably training a machine-learning model to perform entity linking at a large scale.

Some methods of entity linking employ string similarity matching techniques. These string similarity matching techniques typically involve generating a string similarity score (e.g., Hamming distance, Jaro-Winkler distance) by comparing the string of characters in the name of an entity extracted from an information source (e.g., an unknown name) to the string of characters in the names of entities stored in a database (e.g., known names). The unknown name is then assigned to the known name with which it has the highest string similarity score.

String similarity matching techniques, however, can be problematic when used for entity linking. In some aspects, this is because string similarity matching techniques are sensitive to data quality and often fail to account for underlying relationships of the entity names. For example, using metrics for calculating string similarity known to those skilled in the art, an unknown entity name “China Eastern Airlines Yunnan Company” may have a string similarity score of 0.70 with “China Airlines,” a string similarity score of 0.75 with “China Eastern Air,” and a string similarity score of 0.76 with “China Yunnan Hotel Corp.” Thus, a string similarity matching technique may incorrectly determine that “China Eastern Airlines Yunnan Company” is referring to “China Yunnan Hotel Corp.”

Accordingly, there is a need for systems and methods that are able to perform entity linking automatically, accurately, and efficiently. The present disclosure provides solutions that perform entity linking by employing a graph neural network.

### SUMMARY

In one aspect, the present disclosure provides a computer-implemented method for entity linking. According to the method an extraction module retrieves known names and an unknown name. The known names are entity names stored in a database and the unknown name is extracted from an information source. A tokenization module tokenizes the known names and the unknown name. A graph generation module identifies a candidate from the known names. The graph generation module generates a tripartite graph that includes a first layer node corresponding to the unknown name, second layer nodes corresponding to words of the unknown name and the candidate, and a third layer node corresponding to the candidate. A recommendation module applies the tripartite graph to a graph neural network model. The recommendation module assigns the unknown name to one of the known names based on the application of the tripartite graph to the graph neural network model.

In one aspect, the present disclosure provides an entity linking system. The entity linking system can include an extraction module, a tokenization module, a graph generation module, a graph neural network, and a recommendation module. The extraction module can be configured to extract an unknown name from an information source and extract known names from a database. The tokenization module can be configured to tokenize the unknown name and tokenize each one of the known names. The graph generation module can be configured to identify a candidate from the known names and generate a tripartite graph based on the unknown name and the candidate. The tripartite graph can include a first layer node corresponding to the unknown name, second layer nodes corresponding to words of the unknown name and the candidate, and a third layer node corresponding to the candidate. The graph neural network can be configured to generate an unknown name embedding and a candidate embedding based on the tripartite graph. The unknown name embedding corresponds to the first layer node and the candidate embedding corresponds to the third layer node. The recommendation module can be configured to determine a similarity score between the unknown name embedding and the candidate name embedding.

### FIGURES

Various features of the embodiments described herein, together with advantages thereof, may be understood in accordance with the following description taken in conjunction with the accompanying drawings as follows:

FIG. 1 is a diagram illustrating a system for entity linking using a graph neural network, according to at least one aspect of the present disclosure.

FIGS. 2A-2C are tripartite graphs that can be applied to a graph neural network for entity linking, according to several aspects of the present disclosure.

FIG. 3 is a logic flow diagram of a method for entity linking, according to at least one aspect of the present disclosure.

FIG. 4 is a logic flow diagram of a method for assigning an unknown name to one known name from a set of known names by applying a tripartite graph to a graph neural network model, according to at least one aspect of the present disclosure.

FIG. 5 is a logic flow diagram of a method for training a graph neural network model by designating a positive sample, a hard negative sample, and a random negative sample, according to at least one aspect of the present disclosure.

FIG. 6 shows a block diagram of a computer apparatus, according to at least one aspect of the present disclosure.

FIG. 7 shows a block diagram of a system including a host machine, according to at least one aspect of the present disclosure.

Corresponding reference characters indicate corresponding parts throughout the several views. The exemplifications set out herein illustrate various aspects of the present disclosure, in one form, and such exemplifications are not to be construed as limiting the scope of the disclosure in any manner.

### DESCRIPTION

Applicant of the present application owns the following U.S. Provisional Patent Application filed currently herewith, the disclosure of which is herein incorporated by reference in its entirety:
U.S. Provisional Patent Application Docket Number 220265P, titled ENTITY LINKING USING SUBGRAPH MATCHING (6063US01/220265P).

Before explaining various forms of entity linking using a graph neural network, it should be noted that the illustrative forms disclosed herein are not limited in application or use to the details of construction and arrangement of components illustrated in the accompanying drawings and description. The illustrative forms may be implemented or incorporated in other forms, variations and modifications, and may be practiced or carried out in various ways. Further, unless otherwise indicated, the terms and expressions utilized herein have been chosen for the purpose of describing the illustrative forms for the convenience of the reader and are not for the purpose of limitation thereof.

As used herein, the term “computing device” or “computer device” may refer to one or more electronic devices that are configured to directly or indirectly communicate with or over one or more networks. A computing device may be a mobile device, a desktop computer, and/or the like. Furthermore, the term “computer” may refer to any computing device that includes the necessary components to send, receive, process, and/or output data, and normally includes a display device, a processor, a memory, an input device, a network interface, and/or the like.

As used herein, the term “server” may include one or more computing devices which can be individual, stand-alone machines located at the same or different locations, may be owned or operated by the same or different entities, and may further be one or more clusters of distributed computers or “virtual” machines housed within a datacenter. It should be understood and appreciated by a person of skill in the art that functions performed by one “server” can be spread across multiple disparate computing devices for various reasons. As used herein, a “server” is intended to refer to all such scenarios and should not be construed or limited to one specific configuration. The term “server” may also refer to or include one or more processors or computers, storage devices, or similar computer arrangements that are operated by or facilitate communication and processing for multiple parties in a network environment, such as the Internet, although it will be appreciated that communication may be facilitated over one or more public or private network environments and that various other arrangements are possible. Further, multiple computers, e.g., servers, or other computerized devices, directly or indirectly communicating in the network environment may constitute a “system.” Reference to “a server” or “a processor,” as used herein, may refer to a previously-recited server and/or processor that is recited as performing a step or function, a different server and/or processor, and/or a combination of servers and/or processors.

As used herein, the term “system” may refer to one or more computing devices or combinations of computing devices (e.g., processors, servers, client devices, software applications, modules, components of such, and/or the like). For example, a system may include a plurality of computing devices that include software applications, where the plurality of computing devices are connected via a network.

As used herein, the term “module” can refer to a computer-related entity, either hardware, a combination of hardware and software, software, or software in execution.

As used herein, the term “entity” may refer to or include an individual, a company, a business-related organization, a non-profit organization, a governmental organization, a charitable organization, an educational institution, or any other type of individual, group of individuals, or organization.

As used herein, the term “word” may refer to a string of character(s). For example, a word may refer to a string of character(s) that are not separated by a space. The string of character(s) can include one or more characters. The one or more characters can include letter(s), number(s), and/or symbol(s).

As used herein, the term “name” can refer to a word or a string of words. For example, a name can be a word or a string of words which refer to an entity.

As used herein, the term “known,” when used to refer to a name and/or an entity (e.g., a known name, a known entity name, a known entity) can mean that the name and/or entity has been designated or otherwise associated with a particular unique entity. For example, a database storing a set of known names may be used to designate each of the known names as referring to a particular entity.

As used herein, the term “unknown”, when used to refer to a name and/or an entity (e.g., an unknown name, an unknown entity name, an unknown entity), can mean any name and/or entity that is mentioned or otherwise described in an information source. The unknown name, unknown entity name, and/or an unknown entity may or may not have been assigned to a known name or a known entity. As one example, a name that is the target of an entity linking process for assigning the name to a particular known entity and/or a particular known name can be referred to as an unknown name. As another example, a name may have been extracted from an information source and assigned to a known name via an entity linking process. The name may still be referred to as an unknown name even though it has been assigned to a known name. Likewise, the entity described by the name may still be referred to as an unknown entity.

As used herein, the term “tokenize” can refer to a process of classifying and/or separating a string of characters into one or more segments. For example, a name may be tokenized based on words (e.g., word tokenization), subwords (e.g., subword or n-gram tokenization), characters (e.g., character tokenization), etc.

Entity linking is fundamental for any organization to effectively leverage data that is external to the organization. Leveraging external data by an organization is technically quite challenging given the heterogeneous nature of data and the ambient quality of the external data. In accordance with the present disclosure, machine learning is employed to effectively leverage external data. In one aspect, as described in more detail hereinbelow, machine learning techniques are employed to extract structural information from an external entity name based on a variety of factors such as words included in the external entity name, among others. In one aspect, the machine learning techniques include a machine learning model to learn when a matched link should be or should not be in an embedding space. The machine learning techniques according to this disclosure provide a model that is learned from positive and negative linked samples. The following description provides a technical solution for leveraging external data by an organization.

In various aspects, the present disclosure provides solutions that can perform entity linking by using artificial neural networks, such as, for example, a graph neural network, for processing data external to an organization that can be represented as graphs. Convolutional neural networks can be applied in this context to graphs structured as layers of nodes, for example. Performing entity linking using a graph neural network can provide various technological benefits. For example, the systems and methods disclosed herein can allow a computer to more accurately and efficiently perform entity linking by (i) generating a tripartite including nodes corresponding to an unknown name, known names (e.g., candidates), and words of the unknown name and the known names; and (ii) assigning the unknown name to one of the known names by applying the tripartite graph to a graph neural network model.

As another example, the systems and methods disclosed herein can allow particular entities referenced in one or more of the potentially millions of various private and/or public information sources accessible via the Internet to be automatically identified, thereby performing entity linking at a scale that cannot be practically performed in the human mind.

As yet another example, the systems and methods described herein can perform entity linking in a non-routine way by: (i) tokenizing an unknown name and tokenizing known names; (ii) identifying one or more candidates from the known names; (iii) generating a tripartite graph including a first layer node corresponding to the unknown name, second layer nodes corresponding to words of the unknown name and the one or more candidates, and one or more third layer nodes corresponding to the one or more candidates; and (iv) assigning the unknown name to one of the known names by applying the tripartite graph to a graph neural network (e.g., a graph convolutional network). Moreover, the systems and methods described herein can perform entity linking in a non-routine way by supervising the graph neural network model (e.g., a graph convolution network) based on positive samples, hard negative samples, and/or random negative samples.

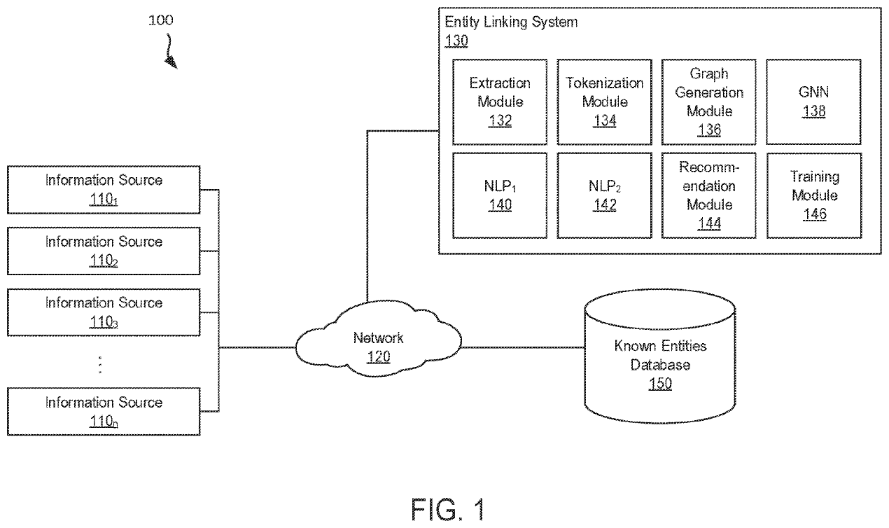

FIG. 1 is a diagram 100 illustrating an entity linking system 130, according to at least one aspect of the present disclosure. The entity linking system 130 can include various modules such as an extraction module 132, a tokenization module 134, a graph generation module 136, a graph neural network 138 (GNN), a first natural language processing module 140 (NLP₁), a second natural language processing module 142 (NLP₂), a recommendation module 144, and/or a training module 146. Although the modules of the entity linking system 130 are described below as separately performing various functions, any of the modules can be configured to perform any combination of the functions described herein. Likewise, multiple modules may be combined into a single module to perform any combination of the functions described herein and/or a single module may be split into multiple submodules with each of the submodules performing any of the functions described herein.

The entity linking system 130 is configured to access or otherwise communicate with one or more information sources 110₁, 110₂, 110₃, . . . 110ₙ (collectively information sources 110) via a network 120. The network 120 can include any variety of wired, long-range wireless, and/or short-range wireless networks. For example, the network 120 can include an internal network, a Local Area Network (LAN), Wi-Fi, a cellular network, a private network, the Internet, a cloud computing network, and/or a combination of these or other types of networks. The information sources 110 can include any type and combination of information sources that include text-based data accessible via the network 120. For example, the information sources 110 can include various private and public information sources such as news articles, wikis, social media, and/or other databases and publications accessible via the Internet.

In the non-limiting aspect of FIG. 1, the entity linking system 130 is also configured to access or otherwise communicate with a known entities database 150 via the network 120. In other aspects, the known entities database 150 can be included as part of the entity linking system 130 (e.g., stored on the same server or combination of servers as the entity linking system 130). The known entities database 150 can include data related to a plurality of known entities. For example, the known entities database 150 can include a list of the names of known entities. As another example, the known entities database 150 can include profiles of known entities that include the names of known entities along with other information related to known entities such as biographical information, financial information, an industry classification, parent company information, subsidiary company information, geographic information, etc. The names of known entities stored in the known entities database 150 are sometimes referred to herein as “known names.”

The extraction module 132 of the entity linking system 130 can be configured to extract information from the information sources 110 and/or the known entities database 150. For example, in one aspect, the extraction module 132 can be configured to detect and extract entity names from text included in the information sources 110. Various techniques may be employed by the extraction module 132 to detect and extract the entity names, such as rule-based named entity recognition (NER) techniques (e.g., techniques employed by General Architecture for Text Engineering (GATE) and rule based NER known as DrNER, among others) and/or machine learning-based NER techniques (e.g., techniques employed by OpenNLP Named Entity Recognizer and Name Finder, free open-source library for Natural Language Processing in Python spaCy, and named entity recognizer SemiNER, among others). In some aspects, the extraction module 132 may be configured to detect the occurrence of an entity name within the information sources 110 without identifying or assigning the entity name to a particular known entity. Accordingly, the entity names detected and extracted from the information sources 110 by the extraction module 132 are sometimes referred to herein as “unknown names.”

In some aspects, the extraction module 132 can be configured to extract a set of known names from the known entities database 150. For example, in one aspect, the extraction module 132 can be configured to retrieve a list of known names from the known entities database 150. In another aspect, where the known entity database 150 includes profiles of known entities, the extraction module 132 can be configured to extract and/or retrieve a set of known names from the profiles.

The tokenization module 134 of the entity linking system 130 can be configured to tokenize the known names and/or the unknown name(s) retrieved by the extraction module 132. In some aspects, the known names and/or the unknown name(s) can be tokenized according to the word(s) included in each of the known names and/or the unknown name(s). In other aspects, the known names and/or the unknown name(s) can be tokenized based on some other criteria such as subword (e.g., n-gram) tokenization or character tokenization. Various NLP tokenization techniques may be employed by the tokenization module 134 to tokenize the known names and/or the unknown name(s) (e.g., white space tokenization, Keras Tokenization, Natural Language Toolkit (NLTK) Word Tokenize, and spaCy Tokenizer, among others). The word(s) generated by tokenizing an unknown name are sometimes referred to herein as “unknown word(s).” Likewise, the word(s) generated by tokenizing a known name are sometimes referred to herein as “known word(s).”

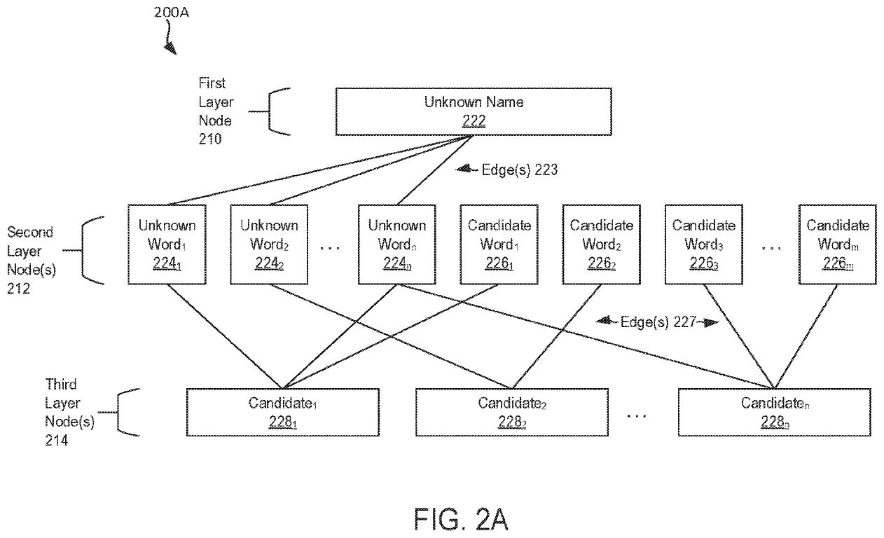

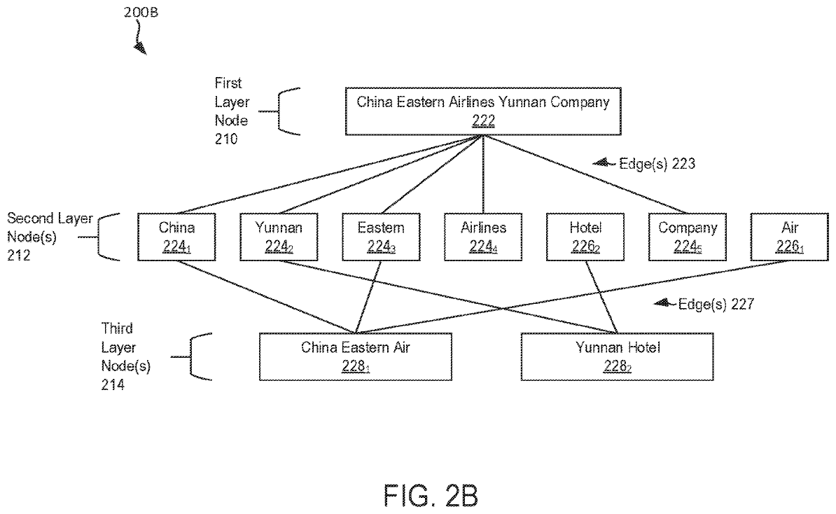

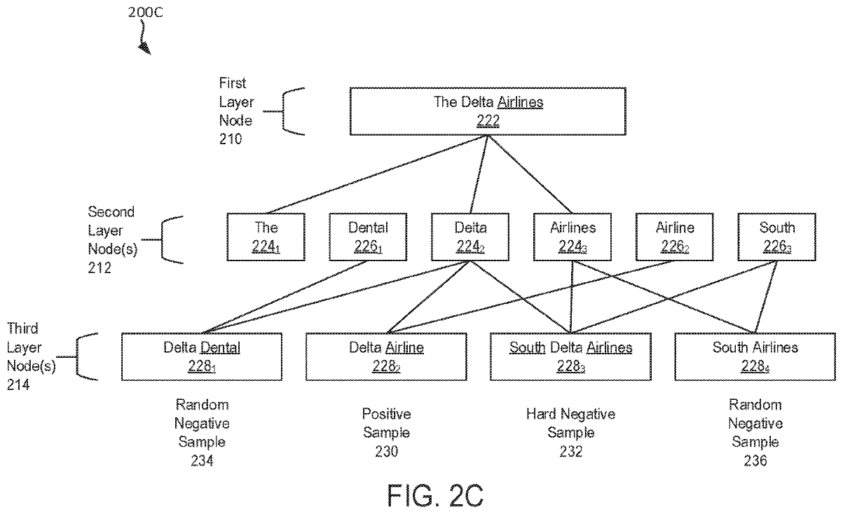

The graph generation module 136 of the entity linking system 130 can be configured to generate a tripartite graph based on an unknown name retrieved by the extraction module 132, the set of known names retrieved the extraction module 132, and words generated by the tokenization module 134 (e.g., the known and unknown word(s)). The structure of the tripartite graph is generally configured to be applied to the GNN 138 so that the unknown name can be assigned to one of the known names. In some aspects, the graph generation module 136 can be configured to generate a tripartite graph having a structure similar to the tripartite graphs 200A-C shown in FIGS. 2A-2C, respectively.

For example, now referring primarily to FIG. 2A and also to FIG. 1, the graph generation module 136 can be configured to identify one or more candidates 228₁, 228₂, . . . 228ₙ (collectively candidate(s) 228) from the set of known names retrieved by the extraction module 132. The candidate(s) 228 are generally known names that the unknown name 222 potentially refers to. Various techniques may be employed by the graph generation module 136 to identify the candidate(s) 228. In one aspect, the graph generation module 136 can be configured to identify the candidate(s) 228 by comparing the words of the unknown name 222 generated by the tokenization module 134 (e.g., unknown word(s) 224₁, 224₂, . . . 224ₙ), to words of the known names generated by the tokenization module 134 (the known words). Any known name having at least one known word that is the same or similar to one of the unknown word(s) 224 can be designated as a candidate 228. The graph generation module 136 may determine whether or not a known word is the same or similar to an unknown word based on a string similarity score (e.g., Hamming distance, Jaro-Winkler distance, etc.). For example, the graph generation module 136 may determine that a known word is the same or similar to an unknown word if the pair of words has a string similarity score of no less than 0.7, such as no less than, 0.8, 0.85, 0.9, 0.95, 0.96, 0.97, 0.98, or no less than 0.99. In another aspect, the graph generation module 136 can be configured to identify each of the known names extracted from the known entities database 150 as a candidate 228. In this aspect, the one or more candidate(s) 228 include all of the known names extracted from the known entities database 150. The known word(s) included in the candidate(s) 228 are sometimes referred to herein as “candidate word(s)” (e.g., candidate word(s) 226₁, 226₂, 226₃, . . . 226ₘ).

Still referring primarily to FIG. 2A and also to FIG. 1, the tripartite graph 200A can be structured to have a first layer node 210, second layer node(s) 212, and third layer node(s) 214. The first layer node 210 corresponds to an unknown name 222 retrieved from an information source 110 by the extraction module 132. The second layer node(s) 212 correspond to the unknown word(s) 224 and the candidate word(s) 226 generated by the tokenization module 134. The third layer node(s) 214 correspond to the candidate(s) 228 identified from the set of known names by the graph generation module 136. Further, the first layer node 210 is connected by an edge 223 to each of the second layer nodes 212 that correspond to an unknown word 224. Each of the third layer node(s) 214 are connected by an edge 227 to each of the second layer nodes 212 corresponding to a candidate word 226 (which also may be an unknown word 224) that is included in the corresponding candidate 228 of the third layer node 214. As noted above, in one aspect, the candidate(s) 228 identified by the graph generation module 136 can include all of the known names extracted from the known entities database 150. Thus, in this aspect, the candidate words(s) 226 are all of the known words. Therefore, the tripartite graph 200A can include second layer node(s) 212 that correspond to each of the known words and third layer node(s) 214 that correspond to each of the known names.

In particular, some candidate word(s) may be the same as an unknown word whereas other candidate word(s) may not be the same as an unknown word. In the cases where one or more candidate words are the same as an unknown word, the tripartite graph 200A includes one second layer node 212 corresponding to the overlapping candidate/unknown words. For example, one of the second layer nodes 212 is shown as corresponding to unknown wordₙ 224ₙ. However, this second layer node 212 also corresponds to a candidate word that is included in candidate₁ 228₁ and a candidate word included in candidateₙ 228ₙ. Thus, the second layer node 212 corresponding to unknown wordₙ 224ₙ is not only connected by an edge 223 to the first layer node 210 but also is connected by edges 227 to the third layer nodes 214 corresponding to candidate₁ 228₁ and candidateₙ 228ₙ. The unknown wordₙ 224ₙ is a word that is included in each of the unknown name 222, the candidate₁ 228₁, and the candidateₙ 228ₙ.

Referring now primarily to FIG. 2B and also to FIG. 1, the tripartite graph 200B is populated with an example unknown name 222, example unknown words 224 and example candidate words 226, and example candidates 228. In the non-limiting aspect of FIG. 2B, the unknown name 222 is “China Eastern Airlines Yunnan Company.” This unknown name may have been extracted from an information source 110, such as an online news article, by the extraction module 132. The unknown words 224 that are generated by tokenizing “China Eastern Airlines Yunnan Company” are “China” 224₁, “Eastern” 224₃, “Airlines” 224₄, “Yunnan” 224₂, “Company” 224₅. Thus, the tripartite graph 200B includes the second layer nodes 212 that correspond to each one of these unknown words 224. Further, the second layer nodes 212 corresponding to the unknown words 224 are connected by edges 223 to the first layer node 210.

Still referring primarily to FIG. 2B and also to FIG. 1, the tripartite graph 200B includes the third layer nodes 214 corresponding to candidates “China Eastern Air” 228₁ and “Yunnan Hotel” 228₂. These candidates 228 may have been identified from a set of known names by the graph generation module 136 because tokenization of each of these names generates at least one word that is the same or similar to an unknown word 224. For example, tokenizing “China Eastern Air” may generate the words “China,” “Eastern,” and “Air,” Thus, the known name “China Eastern Air” may be selected as a candidate because the words “China” and “Eastern” are also generated by tokenizing the unknown name “China Eastern Airlines Yunnan Company.”

Still referring primarily to FIG. 2B and also to FIG. 1, each of the candidate words that are not already included in the tripartite graph 200B as an unknown word 224 second layer node 212 are included as a candidate word 226 second layer node 212. For example, “Hotel” 226₂ is a candidate word that is not the same as one of the unknown words 224. Accordingly, a second layer node 212 is added that corresponds to “Hotel” 226₂. Similarly, “Air” 226₁ is a candidate word that is not the same as one of the unknown words 224. Accordingly, a second layer node 212 is added that corresponds to “Air” 226₁. The third layer nodes 214 are connected by edges 227 to each of the second layer nodes 212 corresponding to a word that is included in the name of the corresponding candidate. For example, the third layer node 214 corresponding to the candidate “China Eastern Air” 228₁ is connected via edges 227 to each of the second layer nodes 212 corresponding to the words “China,” “Eastern,” and “Air.”

In some aspects, in addition to the unknown word 224 and/or the candidate word 226 second layer node 212 that are selected to be included in the tripartite graph 200B as described above, hop neighbors (e.g., all one-hop neighbors; all one-hop and two-hop neighbors; all one-hop, two-hop, and three-hop neighbors, etc.) of these words can be included in the tripartite graph 200B as additional candidate word 226 second layer nodes 212. For example, hop neighbors of an unknown word 226 and/or a candidate word 226 may be identified based on the unknown word embedding and/or the candidate word embedding.

In some aspects, in addition to the candidate(s) 228 that are selected to be included in the tripartite graph 200B as described above, hop neighbors (e.g., all one-hop neighbors; all one-hop and two-hop neighbors; all one-hop, two-hop, and three-hop neighbors, etc.) of the candidate(s) can be included in the tripartite graph 200B as additional candidate 228 third layer nodes 214. For example, hop neighbors of a candidate 226 may be identified based on the candidate embedding. As used herein, a “hop neighbor” of a node (e.g., a first node) may refer to another node (e.g., a second node) that is connected to the node (e.g., the first node) directly via an edge or indirectly via more than one edge. For example, a first node may be directly connected to a second node by an edge. The second node is a one-hop neighbor of the first node. A third node may be directly connected to the second node via another edge but not directly connected to the first node. The third node is a two-hop neighbor of the first node.

Referring again primarily to FIG. 1 and also to FIG. 2A, the GNN 138 and/or the recommendation module 144 of the entity linking system 130 can be configured to perform entity linking based on the tripartite graph generated by the graph generation module 136. To perform the entity linking, the GNN 138 can be configured to generate embeddings corresponding to the nodes of the tripartite graph 200A (e.g., an unknown name embedding corresponding to the first layer node 210, word embedding(s) corresponding to the second layer node(s) 212, and candidate embedding(s) corresponding to the third layer node(s) 214). Further, as explained in detail below, the GNN 138 can be trained such that an unknown name and a candidate name referring to the same unique entity will have a similar representation in the embedding space. The GNN 138 can be any type of GNN, such as a graph convolutional network (GCN), for example.

The recommendation module 144 can be configured to assign the unknown entity to one of the known entities (e.g., one of the candidates) by comparing the unknown name embedding generated by the GNN 138 to each of the candidate embedding(s) generated by the GNN 138. For example, the recommendation module 144 can be configured to determine a similarity score between the unknown name embedding and each of the candidate name embedding(s). In some aspects, the recommendation module 144 can assign the unknown name to one of the known names based on the unknown embedding/candidate embedding pair with the highest similarity score. In addition to or in lieu of the above, the recommendation module 144 can assign the unknown name to one of the known names if the corresponding unknown embedding/candidate embedding pair has a similarity score that satisfies a predetermined threshold, such as a similarity score of no less than 0.7, 0.8, 0.85, 0.9, 0.95, 0.96, 0.97, 0.98, or no less than 0.99. If the similarity score does not satisfy the predetermined threshold, the recommendation module 144 may not assign the unknown name to any of the known names.

In the non-limiting aspect of FIG. 1, the recommendation module 144 is shown as being separate from the GNN 138. However, in other aspects, the recommendation module 144 may be included as a layer of the GNN 138. The recommendation module 144 can employ various techniques to determine the similarity score between the unknown name embedding and the candidate embedding(s). For example, the recommendation module 144 may employ a trained regression model and/or a trained classification model to determine a similarity score between the unknown name embedding and each of the candidate embedding(s).

Referring again primarily to FIG. 2A and also to FIG. 1, the tripartite graph 200A can be used to illustrate how the GNN 138 and the recommendation module 144 can perform entity linking based on a tripartite graph. For example, the GNN 138 may be a GCN. Further, the following functions can represent embeddings that are generated by applying the tripartite graph 200A to the GNN 138:
GCN(“Unknown Name”);
GCN(“Candidate₁”);
GCN(“Candidate₂”);
GCN(“Candidateₙ”).

The following equations represent example similarity scores that can be determined by the recommendation module 144 by comparing the embeddings, where Sim represents the recommendation module 144 used to compare the embeddings:

$$Sim \{ GCN ( “ Unknown Name ” ) , GCN ( “ {Candidate}_{1} ” ) = 0.95$$

$$Sim \{ GCN ( “ Unknown Name ” ) , GCN ( “ {Candidate}_{2} ” ) = 0.25$$

$$Sim \{ GCN ( “ Unknown Name ” ) , GCN ( “ {Candidate}_{n} ” ) = 0.3$$

As indicated by the equations above, the embedding pair corresponding to candidate₁ has the highest similarity score (e.g., 0.95). Accordingly, in some aspects, the recommendation module 144 may link and/or assign the unknown name to candidate₁ based on this pair having the highest similarity score. In other aspects, where the recommendation module 144 requires a minimum similarity score to make an assignment, such as a similarity score of no less than 0.97, the similarity score of 0.95 may not satisfy the threshold and, accordingly, the recommendation module 144 may not make an assignment.

Referring again to FIG. 1, various techniques can be used to train the GNN 138 for entity linking. In some aspects, training the GNN 138 can include initializing the embeddings using various NLP models. Accordingly, the entity linking system 130 can include a first NLP₁ 140 and/or a second NLP₂ 142. The first NLP₁ 140 may be configured to initialize embeddings for nodes of the tripartite graph corresponding to names (e.g., the unknown name, the candidate(s)). For example, the first NLP₁ 140 may employ an NLP model such as BERT (Bidirectional Encoder Representations from Transformers). The second NLP₂ 142 may be configured to initialize embeddings for nodes corresponding to words (e.g., the unknown word(s), the candidate word(s)). For example, the NLP₂ 142 may employ an NLP model such as Word2Vec, WordPiece, etc.

Referring still to FIG. 1, various techniques that can be used to train the GNN 138, such as a ground truth or labeled data set for correct entity linking, may not be available to train the GNN 138. In this instance, the training module 146 may be used to train the GNN 138 using a biased random walk technique. For example, the training module 146 can be used to supervise the GNN 138 during training by designating positive samples, hard negative samples, and/or random negative samples within the tripartite graph. Any of the positive samples, hard negative samples, and/or random negative samples can be identified by comparing the unknown word to one of the candidates. The candidate that the unknown word is compared to during supervised training is sometimes referred to herein as a “target candidate.”

The training module 146 can be used to designate a target candidate that has one or more words in common with the unknown name (e.g., at least one of the candidate words of the target candidate is the same as one of the unknown words). Further, the training module 146 can be used to designate one of the one or more words that is common to both the unknown name and the target candidate as a “target word.” The training module 146 can be configured to compare all of the unknown word(s) that are not the target word to all of the candidate word(s) of the target candidate that are not the target word to determine whether to designate the unknown word and target candidate pair as a positive sample, a hard negative sample, or a random negative sample.

In some aspects, the training module 146 can be configured to designate a positive sample by determining that all of the unknown word(s) that are not the target word and all of the candidate word(s) included in the target candidate that are not the target word have a string similarity score (e.g., Hamming distance, Jaro-Winkler distance) no less than a predetermined threshold such as no less than 0.7, 0.8, 0.85, 0.9, 0.95, 0.96, 0.97, 0.98, or no less than 0.99.

In some aspects, the training module 146 can be configured to designate a hard negative sample by determining that a first subset of all of the unknown word(s) that are not the target word and a first subset of all of the candidate word(s) included in the target candidate that are not the target word have a string similarity score no less than a first predetermined threshold such as no less than 0.7, 0.8, 0.85, 0.9, 0.95, 0.96, 0.97, 0.98, or no less than 0.99 while a second subset of all of the unknown word(s) that are not the target word and a second subset of all of the candidate word(s) included in the target candidate that are not the target word have a string similarity score no greater than a second predetermined threshold such as no greater than 0.7, 0.6, 0.5, 0.4, 0.3, 0.2, or no greater than 0.1.

In some aspects, the training module 146 can be configured to designate a random negative sample by determining that all of the unknown word(s) that are not the target word and all of the candidate word(s) included in the target candidate that are not the target word have a string similarity score no greater than a predetermined threshold such as no greater than 0.7, 0.6, 0.5, 0.4, 0.3, 0.2, or no greater than 0.1.

Referring now primarily to FIG. 2C and also to FIG. 1, the tripartite graph 200C illustrates examples of the positive, hard negative, and random negative samples that may be designated by the training module 146 to train the GNN 138. In the tripartite graph 200C, the unknown name 222 is “The Delta Airlines.” In some aspects, common words such as “The” included in “The Delta Airlines” may be eliminated from consideration during the designation of training samples. Any of the candidates 228 may be target candidates. For example, “Delta Dental” 228₁ and “The Delta Airlines” unknown name 222 both include the target word “Delta.” Identifying all of the unknown words that are not “Delta” in the unknown word “The Delta Airlines” results in the underlined word “Airlines” (excluding “The”). Identifying all of the words of the target candidate “Delta Dental” that are not “Delta” results in the underlined word “Dental.” The string similarity between “Airlines” and “Dental” is likely relatively low (e.g., no greater than the predetermined threshold for random negative samples referenced above). Accordingly, the training module 146 may designate “The Delta Airlines” and “Delta Dental” as a random negative sample 234. The pair of “The Delta Airlines” and “South Airlines” also may be a random negative sample 236 with “Airlines” being the target word and “Delta” and “South” having a relatively low string similarity.

As another example, “Delta Airline” 228₂ and “The Delta Airlines” unknown name 222 both include the target word “Delta.” Identifying all of the words of the target candidate “Delta Airline” that are not “Delta” results in the underlined word “Airline.” The string similarity between “Airlines” and “Airline” is likely relatively high (e.g., no less than the predetermined threshold for positive samples referenced above). Accordingly, the training module 146 may designate “The Delta Airlines” and “Delta Airline” as a positive sample 230.

As yet another example, “South Delta Airlines” 228₃ and “The Delta Airlines” unknown name 222 both include the target word “Delta.” Identifying all of the words of the target candidate “South Delta Airlines” that are not “Delta” results in the underlined words “South” and “Airlines.” The string similarity between “Airlines” and “Airlines” is likely relatively high (e.g., no less than the first predetermined threshold for hard negative samples referenced above). However, string similarity between “Airlines” and “South” is likely relatively low (e.g., no greater than the second predetermined threshold for hard negative samples referenced above). Accordingly, the training module 146 may designate “The Delta Airlines” and “South Delta Airlines” as a hard negative sample 232.

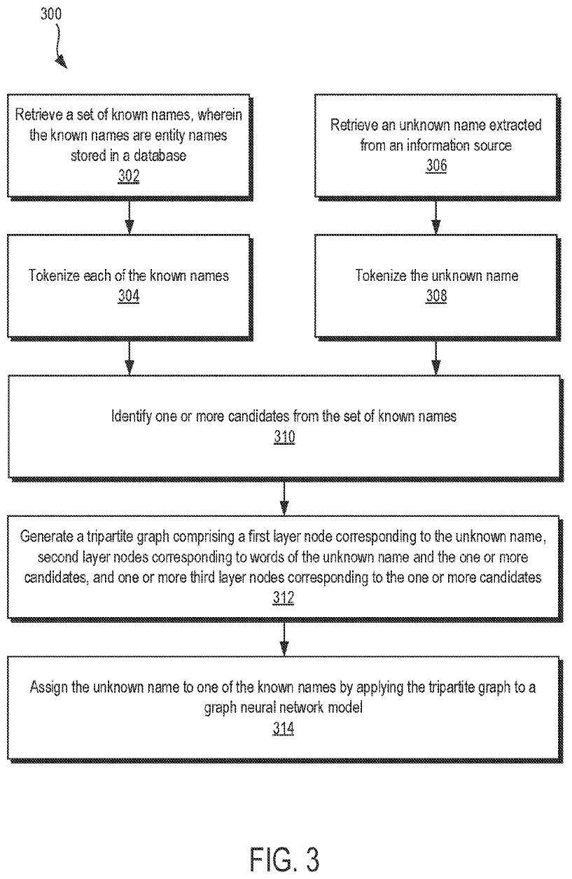

FIG. 3 is a logic flow diagram of a method 300 for entity linking, according to at least one aspect of the present disclosure. The method 300 may be practiced by the entity linking system 130 described above with respect to FIG. 1 and/or any combination of the components of the entity linking system 130. According to the method 300, the extraction module 132 retrieves 302 a set of known names from the known entities database 150. The known names may be entity names that are stored in the known entities database 150. The tokenization module 134 tokenizes 304 each of the known names. Further, according to the method 300, the extraction module 132 retrieves 306 an unknown name from an information source 110. The tokenization module 134 tokenizes 308 the unknown name extracted from the information source 110.

Still referring to FIG. 3, according to the method 300, the graph generation module 136 identifies 310 one or more candidates from the set of known names. Further, the graph generation module 136 generates 312 a tripartite graph. The tripartite graph comprises a first layer node corresponding to the unknown name, second layer nodes corresponding to words of the unknown name and the one or more candidates, and one or more third layer nodes corresponding to the one or more candidates. Further, the recommendation module 144 assigns 314 the unknown name to one of the known names by applying the tripartite graph to the GNN 138.

In one aspect, according to the method 300, identifying 310 one or more candidates from the set of known names can include identifying each of the known names from the set of known names as candidates. In this aspect, the one or more candidates include all of the known names from the set of known names. Further, in this aspect, the tripartite graph comprises a first layer node corresponding to the unknown name, second layer nodes corresponding to words of the unknown name and the known names, and third layer nodes corresponding to the known names.

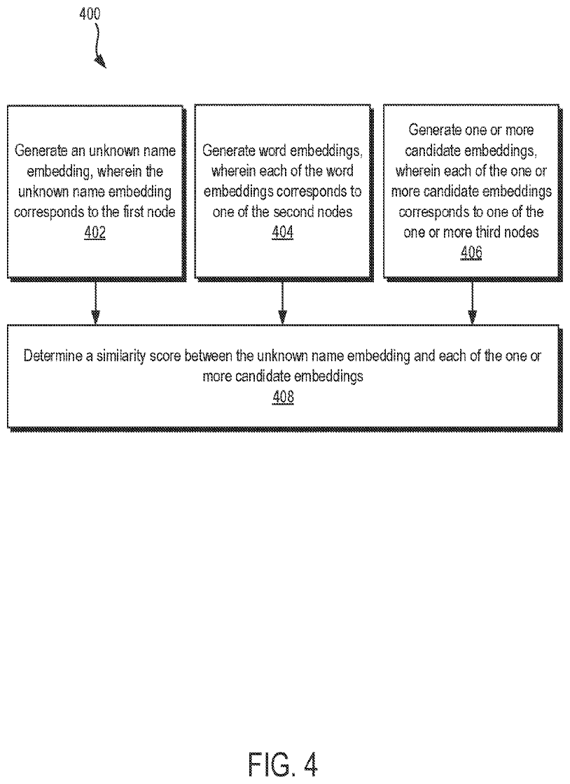

FIG. 4 is a logic flow diagram for a method 400 of assigning an unknown name to one known name from a set of known names by applying a tripartite graph to a graph neural network model, according to at least one aspect of the present disclosure. In some aspects, the method 400 may be included as part of the function of assigning 314 the unknown name to one of the known names described above with respect to FIG. 3. Accordingly, the tripartite graph may include a first node, second nodes, and one or more third nodes. The method 400 may be practiced by the entity linking system 130 described above with respect to FIG. 1 and/or any combination of the components of the entity linking system 130. According to the method 400, the GNN 138 generates 402 an unknown name embedding. The unknown name embedding corresponds to the first node of the tripartite graph. The GNN 138 also may generate 404 word embeddings. Each of the word embeddings correspond to one of the second nodes of the tripartite graph. Further, the GNN 138 generates 406 one or more candidate embeddings. Each of the one or more candidate embeddings corresponds to one of the one or more third nodes of the tripartite graph. In some aspects, the word embeddings and the one or more candidate embeddings are respectively generated 404, 406 by the GNN 138 prior to generating 402 the unknown name embedding (e.g., during training). Thus, in aspects where the entity linking system 130 is used to assign multiple different instances of unknown names to known names, only the unknown name embedding (e.g., not the word embeddings or the one or more candidate embeddings) is newly generated 402 for each unknown name being identified. Referring again to the aspect of the method 400 where a single unknown name is being assigned to one known name from the set of known names, the recommendation module 144 determines 408 a similarity score between the unknown name embedding and each of the one or more candidate embeddings.

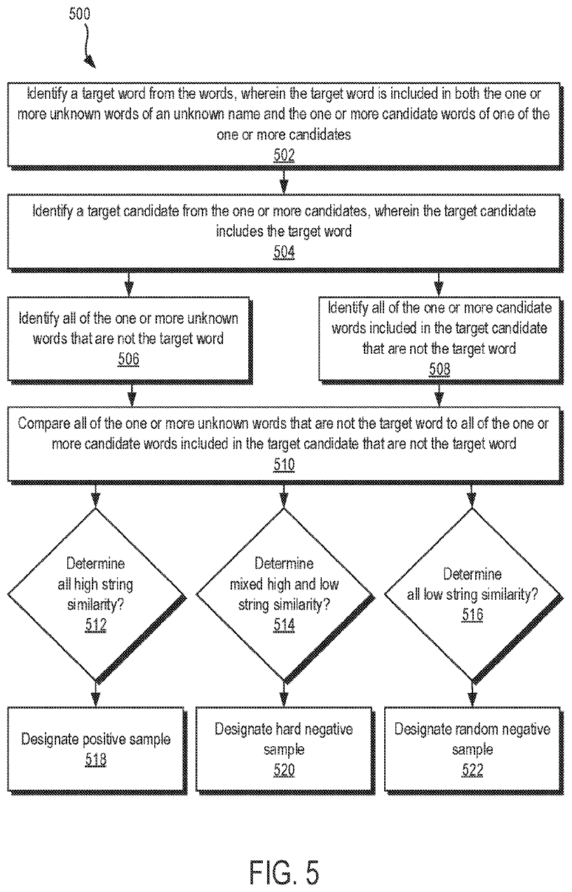

FIG. 5 is a logic flow diagram of a method 500 for training a graph neural network model by designating a positive sample, a hard negative sample, and a random negative sample, according to at least one aspect of the present disclosure. The method 500 may be used to train the GNN 138 that the tripartite graph is applied to by the recommendation module 144 for assigning 314 the unknown name to one of the known names as described above with respect to FIG. 3. Accordingly, the method 500 may be applicable to a tripartite graph structure that comprises a first layer node corresponding to an unknown name, second layer nodes corresponding to words of the known name and one or more candidates, and one or more third layer nodes corresponding to the one or more candidates. The unknown name can include one or more unknown words and each of the candidates can include one or more candidate words. The method 500 may be practiced by the entity linking system 130 described above with respect to FIG. 1 and/or any combination of the components of the entity linking system 130.

Still referring to FIG. 5, according to the method 500, the training module 146 identifies 502 a target word. The target word is included in both the one or more unknown words of the unknown name and the one or more candidate words of one of the one or more candidates. Further, the training module 146 identifies 504 a target candidate from the one or more candidates. The target candidate includes the target word. Also according to the method 500, the training module 146 identifies 506 all of the one or more unknown words that are not the target word and identifies 508 all of the one or more candidate words included in the target candidate that are not the target word. Further, the training module 146 compares 510 all of the one or more unknown words that are not the target word to all of the one or more candidate words included in the target candidate that are not the target word.

Still referring to FIG. 5, if, based on the function of comparing 510, the training module 146 determines 512 that all of the one or more unknown words that are not the target word and all of the one or more candidate words included in the target candidate that are not the target word have a string similarity score no less than a predetermined threshold (e.g., such as no less than 0.7, 0.8, 0.85, 0.9, 0.95, 0.96, 0.97, 0.98, or no less than 0.99), then the training module 146 designates 518 a positive sample.

Still referring to FIG. 5, if, based on the function of comparing 510, the training module 146 determines 514 that: (i) a first subset of the one or more unknown words that are not the target word and a second subset of the one or more candidate words included in the target candidate that are not the target word have a first string similarity score no less than a first predetermined threshold (e.g., such as no less than 0.7, 0.8, 0.85, 0.9, 0.95, 0.96, 0.97, 0.98, or no less than 0.99) and (ii) a third subset of the one or more unknown words that are not the target word and a fourth subset of the one or more candidate words included in the target candidate that are not the target word have a second string similarity score no greater than a second predetermined threshold (e.g., such as no greater than 0.7, 0.6, 0.5, 0.4, 0.3, 0.2, or no greater than 0.1), then the training module 146 designates 520 a hard negative sample.

Still referring to FIG. 5, if, based on the function of comparing 510, the training module 146 determines 516 that all of the one or more unknown words that are not the target word and all of the one or more candidate words included in the target candidate that are not the target word have a string similarity score no greater than a predetermined threshold (e.g., such as no greater than 0.7, 0.6, 0.5, 0.4, 0.3, 0.2, or no greater than 0.1), then the training module 146 designates 522 a random negative sample.

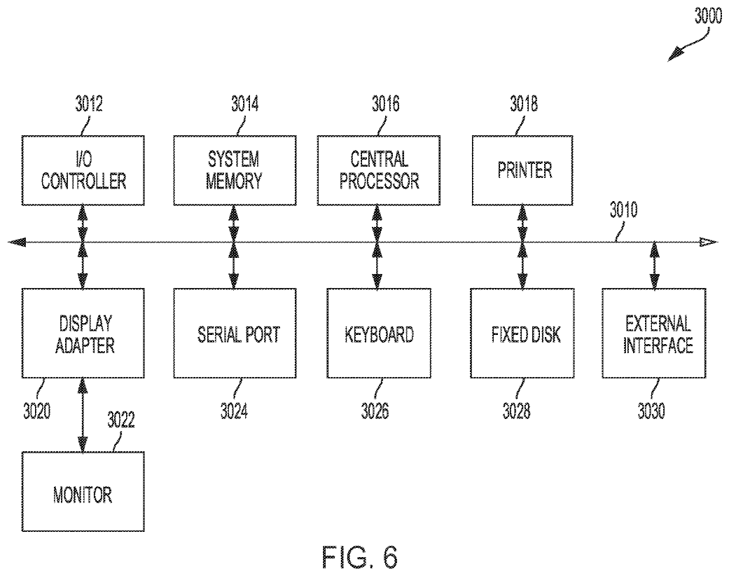

The entity linking system 130 and the modules described herein with reference to FIG. 1 may operate on one or more computer apparatuses to facilitate the functions described herein. Further, the one or more computer apparatuses may use any suitable number of subsystems to facilitate the functions described herein. For example, FIG. 6 is a block diagram of a computer apparatus 3000 with data processing subsystems or components, according to at least one aspect of the present disclosure. The subsystems shown in FIG. 6 are interconnected via a system bus 3010. Additional subsystems such as a printer 3018, keyboard 3026, fixed disk 3028 (or other memory comprising computer readable media), monitor 3022, which is coupled to a display adapter 3020, and others are shown. Peripherals and input/output (I/O) devices, which couple to an I/O controller 3012 (which can be a processor or other suitable controller), can be connected to the computer system by any number of means known in the art, such as a serial port 3024. For example, the serial port 3024 or external interface 3030 can be used to connect the computer apparatus to a wide area network such as the Internet, a mouse input device, or a scanner. The interconnection via system bus allows the central processor 3016 to communicate with each subsystem and to control the execution of instructions from system memory 3014 or the fixed disk 3028, as well as the exchange of information between subsystems. The system memory 3014 and/or the fixed disk 3028 may embody a computer readable medium.

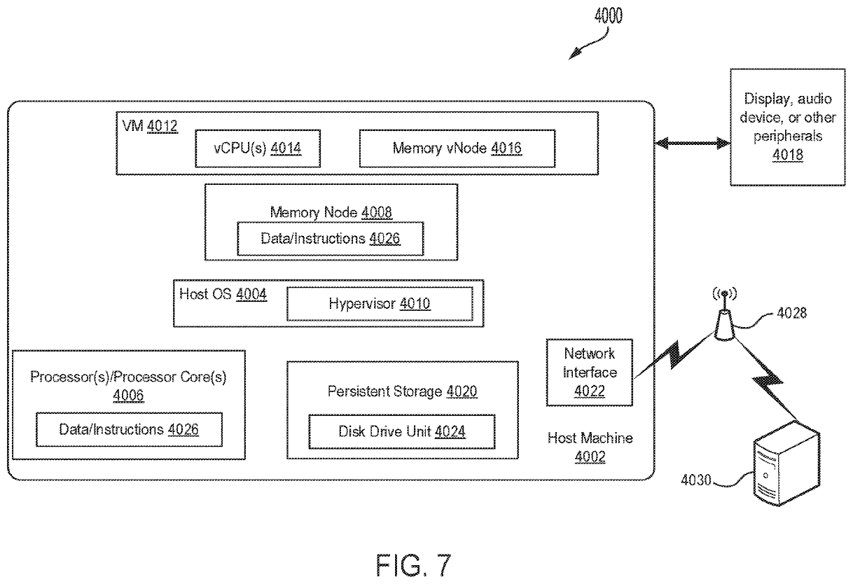

FIG. 7 is a diagrammatic representation of an example system 4000 that includes a host machine 4002 within which a set of instructions to perform any one or more of the methodologies discussed herein may be executed, according to at least one aspect of the present disclosure. In various aspects, the host machine 4002 operates as a standalone device or may be connected (e.g., networked) to other machines. In a networked deployment, the host machine 4002 may operate in the capacity of a server or a client machine in a server-client network environment, or as a peer machine in a peer-to-peer (or distributed) network environment. The host machine 3002 may be a computer or computing device, a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example system 4000 includes the host machine 4002, running a host operating system (OS) 4004 on a processor or multiple processor(s)/processor core(s) 4006 (e.g., a central processing unit (CPU), a graphics processing unit (GPU), or both), and various memory nodes 4008. The host OS 4004 may include a hypervisor 4010 which is able to control the functions and/or communicate with a virtual machine (“VM”) 4012 running on machine readable media. The VM 4012 also may include a virtual CPU or vCPU 4014. The memory nodes 4008 may be linked or pinned to virtual memory nodes or vNodes 4016. When the memory node 4008 is linked or pinned to a corresponding vNode 4016, then data may be mapped directly from the memory nodes 4008 to their corresponding vNodes 4016.

All the various components shown in host machine 4002 may be connected with and to each other, or communicate to each other via a bus (not shown) or via other coupling or communication channels or mechanisms. The host machine 4002 may further include a video display, audio device or other peripherals 4018 (e.g., a liquid crystal display (LCD), alpha-numeric input device(s) including, e.g., a keyboard, a cursor control device, e.g., a mouse, a voice recognition or biometric verification unit, an external drive, a signal generation device, e.g., a speaker,) a persistent storage device 4020 (also referred to as disk drive unit), and a network interface device 4022. The host machine 4002 may further include a data encryption module (not shown) to encrypt data. The components provided in the host machine 4002 are those typically found in computer systems that may be suitable for use with aspects of the present disclosure and are intended to represent a broad category of such computer components that are known in the art. Thus, the system 4000 can be a server, minicomputer, mainframe computer, or any other computer system. The computer may also include different bus configurations, networked platforms, multi-processor platforms, and the like. Various operating systems may be used including UNIX, LINUX, WINDOWS, QNX ANDROID, IOS, CHROME, TIZEN, and other suitable operating systems.

The disk drive unit 4024 also may be a Solid-state Drive (SSD), a hard disk drive (HDD) or other includes a computer or machine-readable medium on which is stored one or more sets of instructions and data structures (e.g., data/instructions 4026) embodying or utilizing any one or more of the methodologies or functions described herein. The data/instructions 4026 also may reside, completely or at least partially, within a main memory portion of the memory node 4008 and/or within the processor(s) 4006 during execution thereof by the host machine 4002. The data/instructions 4026 may further be transmitted or received over a network 4028 via the network interface device 4022 utilizing any one of several well-known transfer protocols (e.g., Hyper Text Transfer Protocol (HTTP)).

The processor(s) 4006 and memory nodes 4008 also may comprise machine-readable media. The term “computer-readable medium” or “machine-readable medium” should be taken to include a single medium or multiple medium (e.g., a centralized or distributed database and/or associated caches and servers) that store the one or more sets of instructions. The term “computer-readable medium” shall also be taken to include any medium that is capable of storing, encoding, or carrying a set of instructions for execution by the host machine 4002 and that causes the host machine 4002 to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example aspects described herein may be implemented in an operating environment comprising software installed on a computer, in hardware, or in a combination of software and hardware.

One skilled in the art will recognize that Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized to implement any of the various aspects of the disclosure as described herein.

The computer program instructions also may be loaded onto a computer, a server, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AlN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud is formed, for example, by a network of web servers that comprise a plurality of computing devices, such as the host machine 4002, with each server 4030 (or at least a plurality thereof) providing processor and/or storage resources. These servers manage workloads provided by multiple users (e.g., cloud resource customers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media, and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one aspect of a bus. Transmission media can also take the form of acoustic or light waves, such as those generated during radio frequency (RF) and infrared (IR) data communications. Common forms of computer-readable media include, for example, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASH EPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object oriented programming language such as Java, Smalltalk, C++, or the like and conventional procedural programming languages, such as the “C” programming language, Go, Python, or other programming languages, including assembly languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Examples of the methods and systems according to various aspects of the present disclosure are provided below in the following numbered clauses. An aspect of any of the method(s) and/or system(s) may include any one or more than one, and any combination of, the numbered clauses described below.
Clause 1. A computer-implemented method, comprising: retrieving, by an extraction module, known names from a database, wherein the known names are entity names stored in the database; tokenizing, by a tokenization module, the known names; retrieving, by the extraction module, an unknown name extracted from an information source; tokenizing, by the tokenization module, the unknown name; identifying, by a graph generation module, a candidate from the known names; generating, by the graph generation module, a tripartite graph comprising a first layer node corresponding to the unknown name, second layer nodes corresponding to words contained in the unknown name and the candidate, and a third layer node corresponding to the candidate; applying, by a recommendation module, the tripartite graph to a graph neural network model; and assigning, by the recommendation module, the unknown name to one of the known names based on the applying, by the recommendation module, of the tripartite graph to the graph neural network model.
Clause 2. The computer-implemented method of Clause 1, wherein the unknown name comprises an unknown word and the candidate comprises a candidate word.
Clause 3. The computer-implemented method of any one of Clauses 1-2, wherein the candidate word is the same as the unknown word.
Clause 4. The computer-implemented method of any one of Clauses 1-2, wherein the identifying the candidate from the known names comprises identifying one of the known names that includes the unknown word.
Clause 5. The computer-implemented method of any one of Clauses 1-4, designating, by a training module, at least one of a positive sample, a negative sample, or a random negative sample; and supervising, by the training module, the graph neural network model based on the designation of the at least one of the positive sample, the negative sample, or the random negative sample.
Clause 6. The computer-implemented method of any one of Clauses 1-5, wherein the unknown name comprises unknown words, wherein the candidate comprises candidate words, and wherein the designating the at least one of the positive sample, the negative sample, or the random negative sample comprises: identifying, by the training module, a target word in the unknown name and the candidate.
Clause 7. The computer-implemented method of any one of Clauses 1-6, wherein the designating the positive sample further comprises: determining, by the training module, that the unknown words that are not the target word and the candidate words that are not the target word have a string similarity score no less than a predetermined threshold.
Clause 8. The computer-implemented method of any one of Clauses 1-7, wherein the designating the hard negative sample further comprises: determining, by the training module, that a first subset of the unknown words that are not the target word and a second subset of the candidate words that are not the target word have a first string similarity score no less than a first predetermined threshold; and determining, by the training module, that a third subset of the unknown words that are not the target word and a fourth subset of the candidate words that are not the target word have a second string similarity score no greater than a second predetermined threshold.
Clause 9. The computer-implemented method of any one of Clauses 1-8, wherein the designating the random negative sample further comprises: determining, by the training module, that the unknown words that are not the target word and the candidate words that are not the target word have a string similarity score no greater than a predetermined threshold.
Clause 10. The computer-implemented method of any one of Clauses 1-9, wherein the graph neural network model is a graph convolutional network model.
Clause 11. The computer-implemented method of any one of Clauses 1-10, wherein the assigning the unknown name to one of the known names based on the applying of the tripartite graph to the graph neural network model comprises: generating, by the graph neural network model: an unknown name embedding that corresponds to the first layer node; word embeddings that correspond to the second layer nodes; and a candidate embedding that corresponds to the third layer node; and determining, by the recommendation module, a similarity score between the unknown name embedding and the candidate embedding.
Clause 12. The computer-implemented method of any one of Clauses 1-11, wherein the determining the similarity score between the unknown name embedding and the candidate embedding comprises applying, by the recommendation module, the unknown name embedding and the candidate embedding to a trained regression model.
Clause 13. The computer-implemented method of any one of Clauses 1-11, wherein the determining the similarity score between the unknown name embedding and the candidate embedding comprises applying, by the recommendation module, the unknown name embedding and the candidate embedding to a trained classification model.
Clause 14. The computer-implemented method of any one of Clauses 1-13, wherein the words contained in the unknown name and the candidate comprise a string of characters not separated by a space.
Clause 15. The computer-implemented method of any one of Clauses 1-14, wherein the tokenizing of the known names comprises performing, by the tokenization module, a word tokenization of the known names, and wherein the tokenizing the unknown name comprises performing, by the tokenization module, the word tokenization of the unknown name.
Clause 16. An entity linking system, comprising: an extraction module configured to extract an unknown name from an information source and extract known names from a database, wherein the known names are names of entities stored in the database; a tokenization module configured to tokenize the unknown name and tokenize the known names; a graph generation module configured to identify a candidate from the known names and generate a tripartite graph based on the unknown name and the candidate, wherein the tripartite graph comprises a first layer node corresponding to the unknown name, second layer nodes corresponding to words contained in the unknown name and the candidate, and a third layer node corresponding to the candidate; a graph neural network configured to generate an unknown name embedding and a candidate embedding based on the tripartite graph, wherein the unknown name embedding correspond to the first layer node, and wherein the candidate embedding corresponds to the third layer node; and a recommendation module configured to determine a similarity score between the unknown name embedding and the candidate embedding.
Clause 17. The entity linking system of Clause 16, wherein the graph neural network is a graph convolutional network.
Clause 18. The entity linking system of any one of Clauses 16-17, wherein the words contained in the unknown name and the candidate comprises a string of characters not separated by a space.
Clause 19. The entity linking system of any one of Clauses 16-18, wherein the words contained in the unknown name and the candidate comprise an unknown word included in the unknown name and a candidate word included in the candidate.
Clause 20. The entity linking system of any one of Clauses 16-19, wherein the graph convolutional network is trained by identifying at least one of a positive sample, a negative sample, or a random negative sample.

Further, it is understood that any one or more of the following-described forms, expressions of forms, examples, can be combined with any one or more of the other following-described forms, expressions of forms, and examples.

Any of the software components or functions described in this application, may be implemented as software code to be executed by a processor using any suitable computer language such as, for example, Python, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

While several forms have been illustrated and described, it is not the intention of Applicant to restrict or limit the scope of the appended claims to such detail. Numerous modifications, variations, changes, substitutions, combinations, and equivalents to those forms may be implemented and will occur to those skilled in the art without departing from the scope of the present disclosure. Moreover, the structure of each element associated with the described forms can be alternatively described as a means for providing the function performed by the element. Also, where materials are disclosed for certain components, other materials may be used. It is therefore to be understood that the foregoing description and the appended claims are intended to cover all such modifications, combinations, and variations as falling within the scope of the disclosed forms. The appended claims are intended to cover all such modifications, variations, changes, substitutions, modifications, and equivalents.

The foregoing detailed description has set forth various forms of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, and/or examples can be implemented, individually and/or collectively, by a wide range of hardware, software, firmware, or virtually any combination thereof. Those skilled in the art will recognize that some aspects of the forms disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as one or more program products in a variety of forms, and that an illustrative form of the subject matter described herein applies regardless of the particular type of signal bearing medium used to actually carry out the distribution.

Instructions used to program logic to perform various disclosed aspects can be stored within a memory in the system, such as dynamic random access memory (DRAM), cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, compact disc, read-only memory (CD-ROMs), and magneto-optical disks, read-only memory (ROMs), random access memory (RAM), erasable programmable read-only memory (EPROM), electrically erasable programmable read-only memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the non-transitory computer-readable medium includes any type of tangible machine-readable medium suitable for storing or transmitting electronic instructions or information in a form readable by a machine (e.g., a computer).

As used in any aspect herein, the term “control circuit” may refer to, for example, hardwired circuitry, programmable circuitry (e.g., a computer processor including one or more individual instruction processing cores, processing unit, processor, microcontroller, microcontroller unit, controller, digital signal processor (DSP), programmable logic device (PLD), programmable logic array (PLA), or field programmable gate array (FPGA)), state machine circuitry, firmware that stores instructions executed by programmable circuitry, and any combination thereof. The control circuit may, collectively or individually, be embodied as circuitry that forms part of a larger system, for example, an integrated circuit (IC), an application-specific integrated circuit (ASIC), a system on-chip (SoC), desktop computers, laptop computers, tablet computers, servers, smart phones, etc. Accordingly, as used herein “control circuit” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

As used in any aspect herein, the term “logic” may refer to an app, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

As used in any aspect herein, the terms “component,” “system,” “module” and the like can refer to a computer-related entity, either hardware, a combination of hardware and software, software, or software in execution.

As used in any aspect herein, an “algorithm” refers to a self-consistent sequence of steps leading to a desired result, where a “step” refers to a manipulation of physical quantities and/or logic states which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities and/or states.

A network may include a packet switched network. The communication devices may be capable of communicating with each other using a selected packet switched network communications protocol. One example communications protocol may include an Ethernet communications protocol which may be capable permitting communication using a Transmission Control Protocol/Internet Protocol (TCP/IP). The Ethernet protocol may comply or be compatible with the Ethernet standard published by the Institute of Electrical and Electronics Engineers (IEEE) titled “IEEE 802.3 Standard”, published in December 2008 and/or later versions of this standard. Alternatively or additionally, the communication devices may be capable of communicating with each other using an X.25 communications protocol. The X.25 communications protocol may comply or be compatible with a standard promulgated by the International Telecommunication Union-Telecommunication Standardization Sector (ITU-T). Alternatively or additionally, the communication devices may be capable of communicating with each other using a frame relay communications protocol. The frame relay communications protocol may comply or be compatible with a standard promulgated by Consultative Committee for International Telegraph and Telephone (CCITT) and/or the American National Standards Institute (ANSI). Alternatively or additionally, the transceivers may be capable of communicating with each other using an Asynchronous Transfer Mode (ATM) communications protocol. The ATM communications protocol may comply or be compatible with an ATM standard published by the ATM Forum titled “ATM-MPLS Network Interworking 2.0” published August 2001, and/or later versions of this standard. Of course, different and/or after-developed connection-oriented network communication protocols are equally contemplated herein.

Unless specifically stated otherwise as apparent from the foregoing disclosure, it is appreciated that, throughout the foregoing disclosure, discussions using terms such as “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

One or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flow diagrams are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

In summary, numerous benefits have been described which result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms and with various modifications as are suited to the particular use contemplated. It is intended that the claims submitted herewith define the overall scope.

The above description is illustrative and is not restrictive. Many variations of the claimed subject matter will become apparent to those skilled in the art upon review of the disclosure. The scope of the present disclosure should, therefore, be determined not with reference to the above description, but instead should be determined with reference to the pending claims along with their full scope or equivalents.

All patents, patent applications, publications, and descriptions mentioned above are herein incorporated by reference in their entirety for all purposes. None is admitted to be prior art.

What is claimed is:

1. A computer-implemented method, comprising:
retrieving, by an extraction module, known names from a database, wherein the known names are entity names stored in the database;
tokenizing, by a tokenization module, the known names;
retrieving, by the extraction module, an unknown name extracted from an information source;
tokenizing, by the tokenization module, the unknown name;
identifying, by a graph generation module, a candidate from the known names;
generating, by the graph generation module, a tripartite graph comprising a first layer node corresponding to the unknown name, second layer nodes corresponding to words contained in the unknown name and the candidate, and a third layer node corresponding to the candidate;
applying, by a recommendation module, the tripartite graph to a graph neural network model; and
assigning, by the recommendation module, the unknown name to one of the known names based on the applying, by the recommendation module, of the tripartite graph to the graph neural network model.

2. The computer-implemented method of claim 1, wherein the unknown name comprises an unknown word and the candidate comprises a candidate word.

3. The computer-implemented method of claim 2, wherein the candidate word is the same as the unknown word.

4. The computer-implemented method of claim 2, wherein the identifying the candidate from the known names comprises identifying one of the known names that includes the unknown word.

5. The computer-implemented method of claim 1, further comprising:
designating, by a training module, at least one of a positive sample, a hard negative sample, or a random negative sample; and
supervising, by the training module, the graph neural network model based on the designation of the at least one of the positive sample, the hard negative sample, or the random negative sample.

6. The computer-implemented method of claim 5, wherein the unknown name comprises unknown words, wherein the candidate comprises candidate words, and wherein the designating the at least one of the positive sample, the hard negative sample, or the random negative sample comprises identifying, by the training module, a target word in the unknown name and the candidate.

7. The computer-implemented method of claim 6, wherein the designating the positive sample further comprises determining, by the training module, that the unknown words that are not the target word and the candidate words that are not the target word have a string similarity score no less than a predetermined threshold.

8. The computer-implemented method of claim 6, wherein the designating the hard negative sample further comprises:
determining, by the training module, that a first subset of the unknown words that are not the target word and a second subset of the candidate words that are not the target word have a first string similarity score no less than a first predetermined threshold; and
determining, by the training module, that a third subset of the unknown words that are not the target word and a fourth subset of the candidate words that are not the target word have a second string similarity score no greater than a second predetermined threshold.

9. The computer-implemented method of claim 6, wherein the designating the random negative sample further comprises:
determining, by the training module, that the unknown words that are not the target word and the candidate words that are not the target word have a string similarity score no greater than a predetermined threshold.

10. The computer-implemented method of claim 1, wherein the graph neural network model is a graph convolutional network model.

11. The computer-implemented method of claim 1, wherein the assigning the unknown name to one of the known names based on the applying of the tripartite graph to the graph neural network model comprises:
generating, by the graph neural network model:
an unknown name embedding that corresponds to the first layer node;
word embeddings that correspond to the second layer nodes; and
a candidate embedding that corresponds to the third layer node; and
determining, by the recommendation module, a similarity score between the unknown name embedding and the candidate embedding.

12. The computer-implemented method of claim 11, wherein the determining the similarity score between the unknown name embedding and the candidate embedding comprises applying, by the recommendation module, the unknown name embedding and the candidate embedding to a trained regression model.

13. The computer-implemented method of claim 11, wherein the determining the similarity score between the unknown name embedding and the candidate embedding comprises applying, by the recommendation module, the unknown name embedding and the candidate embedding to a trained classification model.

14. The computer-implemented method of claim 1, wherein the words contained in the unknown name and the candidate comprise a string of characters not separated by a space.

15. The computer-implemented method of claim 1, wherein the tokenizing of the known names comprises performing, by the tokenization module, a word tokenization of the known names, and wherein the tokenizing the unknown name comprises performing, by the tokenization module, the word tokenization of the unknown name.

16. An entity linking system, comprising:
an extraction module configured to extract an unknown name from an information source and extract known names from a database, wherein the known names are names of entities stored in the database;
a tokenization module configured to tokenize the unknown name and tokenize the known names;
a graph generation module configured to identify a candidate from the known names and generate a tripartite graph based on the unknown name and the candidate, wherein the tripartite graph comprises a first layer node corresponding to the unknown name, second layer nodes corresponding to words contained in the unknown name and the candidate, and a third layer node corresponding to the candidate;
a graph neural network configured to generate an unknown name embedding and a candidate embedding based on the tripartite graph, wherein the unknown name embedding correspond to the first layer node, and wherein the candidate embedding corresponds to the third layer node; and
a recommendation module configured to determine a similarity score between the unknown name embedding and the candidate embedding.

17. The entity linking system of claim 16, wherein the graph neural network is a graph convolutional network.

18. The entity linking system of claim 17, wherein the words contained in the unknown name and the candidate comprise a string of characters not separated by a space.

19. The entity linking system of claim 18, wherein the words contained in the unknown name and the candidate comprise an unknown word included in the unknown name and a candidate word included in the candidate.

20. The entity linking system of claim 19, wherein the convolution graph network is trained by identifying at least one of a positive sample, a hard negative sample, or a random negative sample.
